(19) United States
(12) Patent Application Publication
(10) Pub. No.: US 2010/0005628 A1
(43) Pub. Date: Jan. 14, 2010

(54) Hood Hinge Structure for Vehicle

(75) Inventor: Young Min Jung, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/400,709

(22) Filed: Mar. 9, 2009

(30) Foreign Application Priority Data
Jul. 9, 2008 (KR) 10-2008-0066643

(51) Int. Cl. E05D 5/10; B60R 99/00

(52) U.S. Cl. 16/386; 296/193.11

(57) ABSTRACT

A hood hinge apparatus for a vehicle is provided. The hood hinge apparatus may include a hood arm fixed to a side of a rear end of a hood panel, a hood bracket fixed to one side of a chassis corresponding to the hood arm, and a hinge pin for pivotally connecting the hood arm and the hood bracket. The hood arm includes a coupling member with one end pivotally coupled to the hood bracket by the hinge pin and the other end supported by a lower portion of the hood panel, an arm member with one side rotatably hinged to an upper end of the coupling member and the other side fixed to the hood panel, and a resilient member provided on a hinged portion of the arm member and the coupling member for resiliently supporting the arm member.

### CROSS-REFERENCE TO RELATED APPLICATION

The present application claims priority from Korean Patent Application No. 10-2008-0066643 filed Jul. 9, 2008, the entire contents of which is incorporated herein for all purposes by this reference.

### BACKGROUND OF THE INVENTION

1. Field of the Invention

The present invention relates to a hood hinge apparatus for a vehicle, and more particularly, to a hood hinge apparatus for a vehicle that can increase the strain of a hood panel when a pedestrian is hit by a vehicle, and thus decrease the impact applied to the pedestrian hit by the vehicle to minimize the risk of pedestrian injury.

2. Description of Related Art

In general, a vehicle is provided with a hood panel for covering an engine compartment. Such a hood panel includes a hood locking device for fixing the hood panel to a chassis of the vehicle. The hood locking device has a spring, and is coupled to a release lever installed inside of the engine compartment.

If a driver manipulates the release lever coupled to the hood locking device, the front end of the hood panel is slightly raised. Then, the driver puts his or her hand between the chassis and the hood panel, and then releases an auxiliary lever to open the hood panel.

In the state where the hood panel is opened, the opened state of the hood panel is maintained by using hood supports provided at both sides of the hood panel.

Also, the hood panel is provided with hood hinge assemblies at both sides thereof, in which the hood panel is pivotally opened by the hood hinge assemblies.

The hood hinge apparatus is generally classified into a pin hinge type and a link hinge type. Since the pin hinge type has a simple construction and the reduced number of components, it is applied to small vehicles. The link hinge type is applied to vehicles with a heavy hood.

FIGS. 1 and 2 show a conventional hood hinge apparatus for a vehicle.

A vehicle generally includes, as shown in FIG. 1, an engine compartment for accommodating an engine, a transmission, and various devices in the front of the vehicle that are required for a vehicle to travel, and a hood panel 10 for protecting the engine compartment against the exterior.

The hood panel 10 is provided at the rear end thereof with a hood 20 for hingedly fixing the hood panel 10 to a chassis of the vehicle so that the hood panel 10 can be opened upwardly from the chassis. The hood 20 includes a hood arm 21, a hood bracket 22 and a hinge pin 23.

The hood arm 21 is fixed to one lower side of the hood panel 10 by fastening bolts which are fastened to engaging holes 21a.

The hood bracket 22 is fixed by fastening bolts, which are fastened to engaging holes 22a, to one side of the chassis of the vehicle that corresponds to the hood arm 21.

The hinge pin 23 pivotally connects the hood arm 21 with the hood bracket 22.

The hood panel 10 can be conveniently rotated upwardly by the hood 20.

Referring to FIG. 3, when a pedestrian is hit by a vehicle, a pedestrian's head collides against the upper portion of the vehicle. In this instance, the impact is absorbed by deformation of the hood panel 10 with the hood 20, thereby minimizing the risk of the pedestrian injury.

Since both ends of the hood panel 10 are fixed to the hood arm 21 of the hood 20, a deformable area of the hood panel for absorbing the impact is reduced. Consequently, the rigidity of the hood panel in a longitudinal direction thereof is remarkably increased, and thus the impact applied to the pedestrian is also increased, thereby elevating the risk of injury.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Accordingly, various aspects of the present invention are directed to solving the above-mentioned problems of the prior art while maintaining certain advantages of the prior art.

One aspect of the present invention is directed to a hood hinge apparatus for a vehicle. The apparatus may include a hood arm fixed to a lower portion of a hood panel, a hood bracket fixed to one side of a chassis of the vehicle, and/or a hinge pin pivotally connecting the hood arm and the hood bracket. The hood arm may include a coupling member with a first end pivotally coupled to the hood bracket by the hinge pin and a second end supported by the lower portion of the hood panel, and/or an arm member with a first end rotatably hinged to the second end of the coupling member and a second end fixed to the lower portion of the hood panel, so that when an external force is applied to the hood panel, the arm member rotates around the hinged portion from the coupling member in accordance with deformation of the hood panel.

The coupling member may include an engaging hole. The arm member may include an engaging hole. A resilient member may be provided on the hinged portion of the arm member and the coupling member for resiliently supporting the arm member against the deformation of the hood panel. A support portion may protrude from the first end of the arm member around the hinged portion onto the second end of the coupling member, and may support a portion of the coupling member. A support portion may protrude from the first end of the arm member around the hinged portion onto the second end of the coupling member, and supports a portion of the coupling member.

Another aspect of the present invention is directed to a hood hinge apparatus for a vehicle. The apparatus may include a hood arm fixed to a lower portion of a hood panel at rear end thereof, a hood bracket fixed to one side of a chassis of the vehicle, and/or a hinge pin pivotally connecting the hood arm and the hood bracket in a traverse direction of the hood panel. The hood arm may include a coupling member aligned in a longitudinal direction of the hood panel, the coupling member with a first end pivotally coupled to the hood bracket by the hinge pin and a second end supported by the lower portion of the hood panel, and/or an arm member offset from the hinge pin with a predetermined distance in the longitudinal direction of the hood panel, the arm member with a first end rotatably hinged to the second end of the coupling member and a second end fixed to the lower portion of the hood panel, so that when an external force is applied to the hood panel, the arm member may be rotated around the hinged portion from the coupling member in accordance with deformation of the hood panel, wherein the hinged portion may be aligned in the longitudinal direction of the hood panel.

The coupling member may include an engaging hole. The arm member may include an engaging hole. An angular degree between the arm member and the coupling member with respect to longitudinal axis of the hinged portion may be less than 180 degrees. A resilient member may be provided on the hinged portion of the arm member and the coupling member for resiliently supporting the arm member against the deformation of the hood panel. A support portion may protrude from the first end of the arm member around the hinged portion onto the second end of the coupling member, and/or may support a portion of the coupling member. A support portion may protrude from the first end of the arm member around the hinged portion onto the second end of the coupling member, and supports a portion of the coupling member.

A passenger vehicle may include any of the above-mentioned the hood hinge apparatuses. An angular degree between the arm member and the coupling member with respect to longitudinal axis of the hinged portion may be less than 180 degrees.

With the above-described construction, when an external force is applied to the hood panel, the hood arm is rotated downwardly in accordance with deformation of the hood panel. Consequently, the hood hinge apparatus decreases the impact applied to a pedestrian and thus minimizes the risk of pedestrian injury, thereby improving the safety.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a plan view illustrating a conventional hood hinge apparatus for a vehicle.

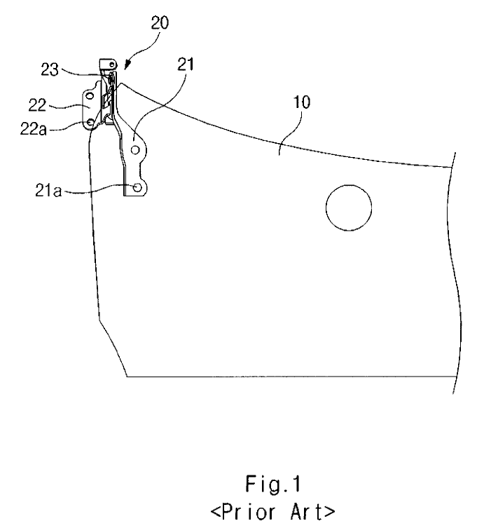

FIG. 2 is a perspective view illustrating the hood hinge apparatus in FIG. 1.

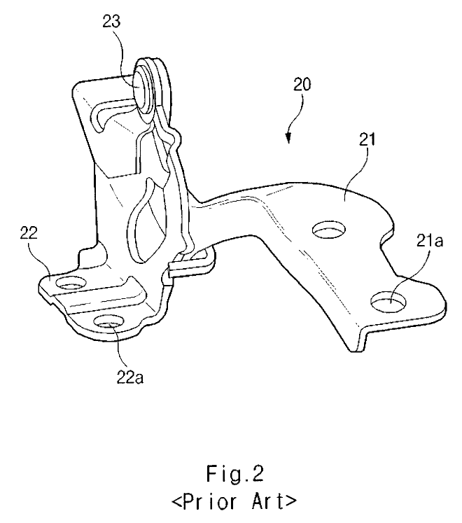

FIG. 3 is a view illustrating the operation of a conventional hood hinge apparatus for a vehicle.

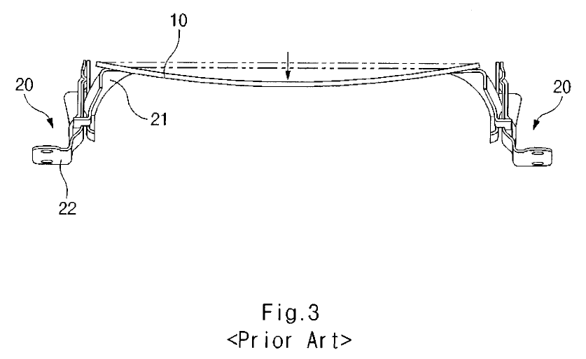

FIG. 4 is a perspective view illustrating an exemplary hood hinge apparatus for a vehicle according to an aspect of the present invention.

FIG. 5 is a cross-sectional view taken along line A-A in FIG. 4.

FIG. 6 is a view illustrating the operation of an exemplary hood hinge apparatus for a vehicle according to an aspect of the present invention.

FIG. 7 is a cross-sectional view illustrating an exemplary hood hinge apparatus according to another aspect of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

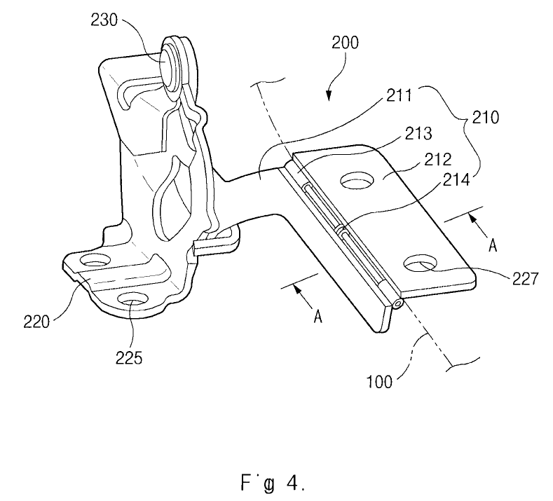

A hood hinge apparatus for a vehicle according to an exemplary embodiment of the present invention will now be described in detail with reference to FIGS. 4 to 7.

A vehicle is provided with an engine compartment for accommodating an engine, a transmission and various devices in the front of the vehicle, and also a hood panel 100 for protecting the engine compartment against the exterior.

The hood panel 100 is provided at both rear sides thereof with a hood hinge apparatus 200, respectively, so that the hood panel 100 can be opened upwardly.

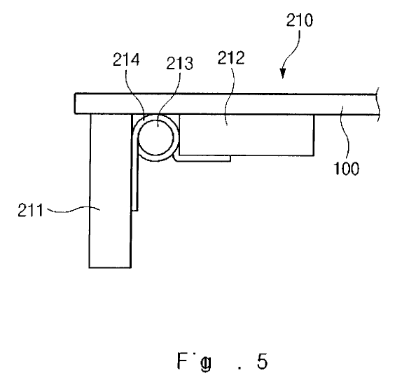

The hood hinge apparatus 200 is configured to easily rotate the hood panel 100 upwardly at the rear side thereof, as shown in FIGS. 4 and 5. The hood hinge apparatus 200 includes a hood arm 210 fixed to the lower portion of the hood panel 100 by a plurality of bolts, a hood bracket 220 fixed to one side of a chassis of a vehicle corresponding to the hood arm 210 by a plurality of bolts, and a hinge pin 230 for pivotally connecting the hood arm 210 and the hood bracket 220 in a traverse direction of the hood panel 100.

With the construction of the hood hinge apparatus 200, one end of the hood arm 210 is pivotally supported by the upper portion of the hood bracket 220 via the hinge pin 230, so that the hood bracket 220 and the hood arm 210 are rotatably fixed to the hood panel 100 and the chassis.

The hood bracket 220 is put on the chassis of the vehicle, and then is fixed to the chassis by a plurality of bolts which are fastened to the engaging holes 225 formed on the lower portion of the hood bracket 220.

The other end of the hood arm 210 is displaced under the lower portion of the hood panel 100, and then is fixed to the hood panel 100 by a plurality of bolts which are fastened to the engaging holes 227 formed on the other end of the hood arm 210.

The hood arm 210 is configured to rotate in accordance with deformation of the hood panel, when external force is applied to the upper portion of the hood panel 100.

The hood arm 210 includes a coupling member 211, an arm member 212, and an hinge member 213.

The coupling member 211 with one end is pivotally coupled to the hood bracket 220 by the hinge pin 230 in the traverse direction of the hood panel 100 and the other end supported by the lower portion of the hood panel 100.

The arm member 212 with one side is rotatably hinged to the upper end of the coupling member 211 and the other side fixed to the lower portion of the hood panel 100.

The hinge member 213 is aligned in a longitudinal direction of the hood panel 100 and rotatably couples the arm member 212 and the coupling member 211.

The resilient member 214 is aligned in a longitudinal direction of the hood panel 100 and is coupled with a center potion thereof to the hinge member 213, one end supported by the arm member 212 and the other end supported by the side of the coupling member 211 to resiliently support the arm member 212.

With the construction of the hood arm 210, the arm member 212 is rotatably hinged to one side of the coupling member 211 fixed to lower portion of the hood panel 100. When the external force is applied to the hood panel 100 from the outside, the arm member 212 pivotally coupled to the coupling member 211 in a longitudinal direction of the hood panel 100 is rotated downwardly around the hinge member 213 in accordance with the downward deformation of the hood panel 100.

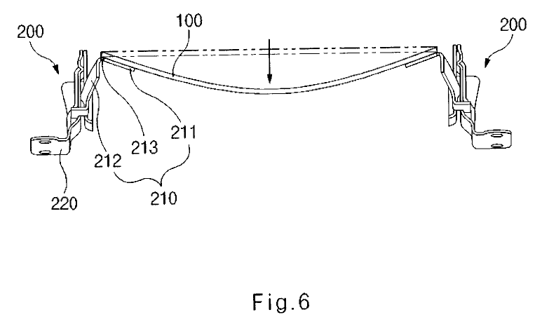

The operation of the hood hinge apparatus for the vehicle according to the present invention will now be described in detail with reference to FIG. 6.

First of all, if a pedestrian is hit by a vehicle, usually a pedestrian's knee collides against a bumper of the vehicle, and then a pedestrian's head secondarily collides against the upper portion of the hood panel 100.

Since the hood panel 100 is made of a thin panel, the hood panel is deformed downwardly by the collision with the pedestrian's head, thereby absorbing the impact. Simultaneously, the hood hinge assemblies 200 provided at both lateral sides of the hood panel 100 are deformed in accordance with the hood panel, thereby increasing the strain of the hood panel 100.

More specifically, if the hood panel 100 is deformed downwardly, both sides of the hood panel 100 are bent downwardly, as shown in FIG. 6. Also, as the arm member 212 of the hood arm 210, fixed to the hood panel 100, is rotated downwardly around the hinge member 213, the strain of the hood panel 100 is increased due to the hood hinge apparatus 200, thereby effectively absorbing the impact applied to the pedestrian.

In addition, in another exemplary embodiment of the present invention, since the arm member 211 is resiliently supported by the resilient member 214, the hood panel 100 is resiliently supported so that it is not rapidly deformed. Consequently, the impact applied to the pedestrian is decreased.

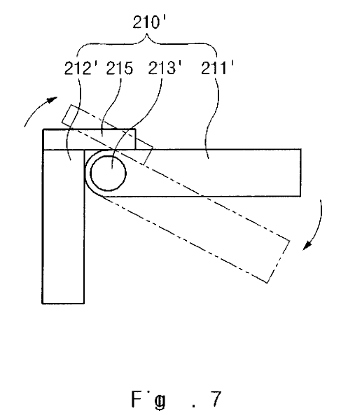

FIG. 7 shows a hood arm 210′ according to various embodiments of the present invention.

In the illustrated exemplary embodiment, the same reference numerals are used for the same elements as the above embodiments, and the detailed description thereof will be omitted.

The hood arm 210′ includes a support portion 215 protruding from one side of an arm member 212′ corresponding to one side of a coupling member 211′. The support portion 215 is dimensioned and configured to support the upper portion of the coupling member 211′, so that the arm member 212′ is aligned in a horizontal direction.

More specifically, the support portion 215 is provided on one side of the coupling member 211′ to allow the arm member 212′ to rotate downwardly in the horizontal state, thereby improving the mounting ability of the hood hinge structure.

In various embodiments of the present invention, the coupling member 211′ and the arm member 212′ may be coupled by a resilient member with a center portion coupled to the hinge member 213′, one end supported by the arm member 212′ and the other end supported by the coupling member 211′ to resiliently support the arm member 212′.

For convenience in explanation and accurate definition in the appended claims, the terms “up” or “upper”, “down” or “lower”, “front” or “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hood hinge apparatus for a vehicle, comprising:
a hood arm fixed to a lower portion of a hood panel;
a hood bracket fixed to one side of a chassis of the vehicle; and
a hinge pin pivotally connecting the hood arm and the hood bracket,
wherein the hood arm includes:
a coupling member with a first end pivotally coupled to the hood bracket by the hinge pin and a second end supported by the lower portion of the hood panel; and
an arm member with a first end rotatably hinged to the second end of the coupling member and a second end fixed to the lower portion of the hood panel, so that when an external force is applied to the hood panel, the arm member rotates around the hinged portion from the coupling member in accordance with deformation of the hood panel.

2. The hood hinge apparatus as claimed in claim 1, wherein the coupling member includes an engaging hole.

3. The hood hinge apparatus as claimed in claim 1, wherein the arm member includes an engaging hole.

4. The hood hinge apparatus as claimed in claim 1, wherein a resilient member is provided on the hinged portion of the arm member and the coupling member for resiliently supporting the arm member against the deformation of the hood panel.

5. The hood hinge apparatus as claimed in claim 4, wherein a support portion protrudes from the first end of the arm member around the hinged portion onto the second end of the coupling member, and supports a portion of the coupling member.

6. The hood hinge apparatus as claimed in claim 1, wherein a support portion protrudes from the first end of the arm member around the hinged portion onto the second end of the coupling member, and supports a portion of the coupling member.

7. A hood hinge apparatus for a vehicle, comprising:
a hood arm fixed to a lower portion of a hood panel at rear end thereof;
a hood bracket fixed to one side of a chassis of the vehicle; and
a hinge pin pivotally connecting the hood arm and the hood bracket in a traverse direction of the hood panel,
wherein the hood arm includes:
a coupling member aligned in a longitudinal direction of the hood panel, the coupling member with a first end pivotally coupled to the hood bracket by the hinge pin and a second end supported by the lower portion of the hood panel; and
an arm member offset from the hinge pin with a predetermined distance in the longitudinal direction of the hood panel, the arm member with a first end rotatably hinged to the second end of the coupling member and a second end fixed to the lower portion of the hood panel, so that when an external force is applied to the hood panel, the arm member is rotated around the hinged portion from the coupling member in accordance with deformation of the hood panel, wherein the hinged portion is aligned in the longitudinal direction of the hood panel.

8. The hood hinge apparatus as claimed in claim 7, wherein the coupling member includes an engaging hole.

9. The hood hinge apparatus as claimed in claim 7, wherein the arm member includes an engaging hole.

10. The hood hinge apparatus as claimed in claim 7, wherein an angular degree between the arm member and the coupling member with respect to longitudinal axis of the hinged portion is less than 180 degrees.

11. The hood hinge apparatus as claimed in claim 7, wherein a resilient member is provided on the hinged portion of the arm member and the coupling member for resiliently supporting the arm member against the deformation of the hood panel.

12. The hood hinge apparatus as claimed in claim 11, wherein a support portion protrudes from the first end of the arm member around the hinged portion onto the second end of the coupling member, and supports a portion of the coupling member.

13. The hood hinge apparatus as claimed in claim 7, wherein a support portion protrudes from the first end of the arm member around the hinged portion onto the second end of the coupling member, and supports a portion of the coupling member.

14. A passenger vehicle comprising the hood hinge apparatus as claimed in claim 1.

15. A passenger vehicle comprising the hood hinge apparatus as claimed in claim 7.

16. The passenger vehicle as claimed in claim 15, wherein an angular degree between the arm member and the coupling member with respect to longitudinal axis of the hinged portion is less than 180 degrees.
